(19) United States
(12) Patent Application Publication
(10) Pub. No.: US 2006/0206921 A1
(43) Pub. Date: Sep. 14, 2006

(54) Intrusion-free computer architecture for information and data security

(76) Inventor: Shuangbao Wang, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 11/373,135

(22) Filed: Mar. 13, 2006

Related U.S. Application Data
(60) Provisional application No. 60/660,857, filed on Mar. 12, 2005.

(51) Int. Cl. H04L 9/32

(52) U.S. Cl. 726/3

(57) ABSTRACT

A computer architecture is disclosed where the system includes a first computer bus, network interface, bus controller and temporary storage. A first computer can receive data from a network and store data in its memory or temporary storage. To have safe data, the architecture demands using the bus controller to selectively control data flow and verify data. The bus controller includes a first interface, second interface and third interface. These interfaces aid the process of data flow and verification. If data is verified, a computer operator may use the bus controller to select and transmit verified data to the main (second) computer. Additionally, data flow may be reversible. Trusted data may be exported from any storage component associated with the second computer through the bus controller to any storage component associated with the first computer. From the latter, data may be exported to the network through the network interface.

### CROSS REFERENCE TO RELATED APPLICATIONS

The present application claims the benefit of provisional patent application Ser. No. 60/660,857 to Wang, filed on Mar. 12, 2005, entitled “Intrusion-free Computer Architecture for Information and Data Security,” which is hereby incorporated by reference.

### BACKGROUND

Technological advancements have led to the possibility of unauthorized retrieval of data stored on computers. With the aid of the Internet, computer hackers can invade and access personal information (such as social security numbers, credit card numbers, bank accounts, etc.) stored on computers. Without a secure means of protection, this information may be vulnerable.

Two major concerns are privacy and identify theft. With respect to privacy, some employers are using centralized monitoring software. Such use may cause employees to be fearful of storing private information into company computers. This kind of software is often used to monitor an employee's e-mails, web browsing, etc.

Identity theft is a more serious problem than privacy. According to Time magazine, nearly 10 million people were victimized by identity theft in 2004. Even companies are not immune. For example, in March 2005, data from the nation's largest data miner, namely ChoicePoint, was infiltrated. At that time, ChoicePoint had approximately 19 billion data files, including driver's licenses, social security numbers, credit histories, birth certificates, real estate deeds, thumbprints, etc. When its system was breached, about 145,000 people had their data extracted.

There are some mechanisms to help detect and thwart possible intrusions. One example is a firewall. However, it is not indefinitely effective. Generally, hackers have been successful in overcoming firewalls by writing and executing code to circumvent firewalls. While some firewalls are purely software, others implement “hardware” to set up a “wall” between the computer and the outside world. Nevertheless, these “hardware” are still software based because the core components are premised on algorithms.

### BRIEF DESCRIPTION OF THE DRAWINGS

FIG. 1 is a block diagram of the John von Neumann computer architecture model.

FIG. 2 is a block diagram of the John von Neumann computer architecture model represented as a system bus.

FIG. 3 is an embodied block diagram of a modified Neumann computer architecture.

FIG. 4 is an embodied block diagram of an intrusion-free computer architecture.

FIG. 5 is an embodied block diagram of the bus controller.

FIG. 6 is another embodied block diagram of the bus controller.

FIG. 7 is one aspect of a flow diagram for protecting data residing on a second computer from malicious actions originating from a network.

FIG. 8 is another aspect of a flow diagram for protecting data residing on a second computer from malicious actions originating from a network.

FIG. 9 is yet another aspect of a flow diagram for protecting data residing on a second computer from malicious actions originating from a network.

### DETAILED DESCRIPTION

The disclosure deals with a computer architecture that enables computers to prevent intruders from acquiring data stored in the computer system. In particular, this computer architecture involves a bus controller.

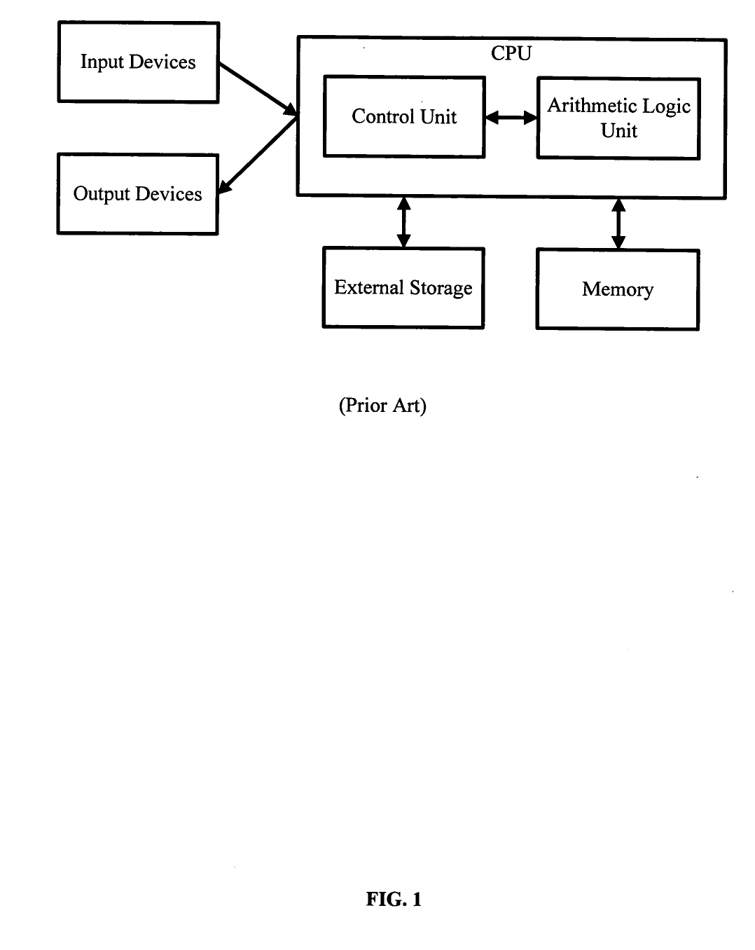

John von Neumann outlined a stored-program computer architecture (“Neumann model”) in his paper “First Draft of a Report on the EDVAC.” This proposed computer concept has characterized mainstream computer architecture since 1945. As shown in FIG. 1, this concept includes a central processing unit (CPU) having a centralized control unit and an arithmetic logic unit, an input device, an output device, an external storage, and a memory. Examples of input/output (I/O) devices include a keyboard, display, printer, etc.

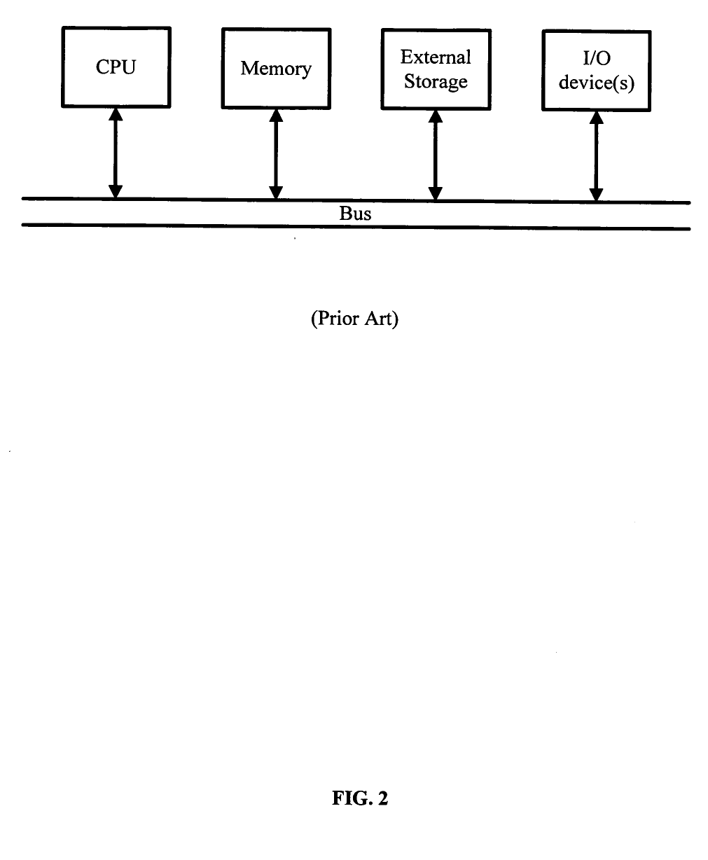

The Neumann model can also be represented as a “system bus”, as depicted in FIG. 2. The Neumann model's components (i.e., the CPU, memory, external storage, and network interface) are all connected to one system bus. This single system bus can include a control bus, data bus and an address bus. It can also include Direct Memory Access (DMA).

Neumann's conception captured the notion of computers as stand alone machines. Without more, these pre-Internet machines could not perform today's global exchange of data over a network. What is lacking from the Neumann model is a vital network component, even though some may argue that the network component is part of an I/O device.

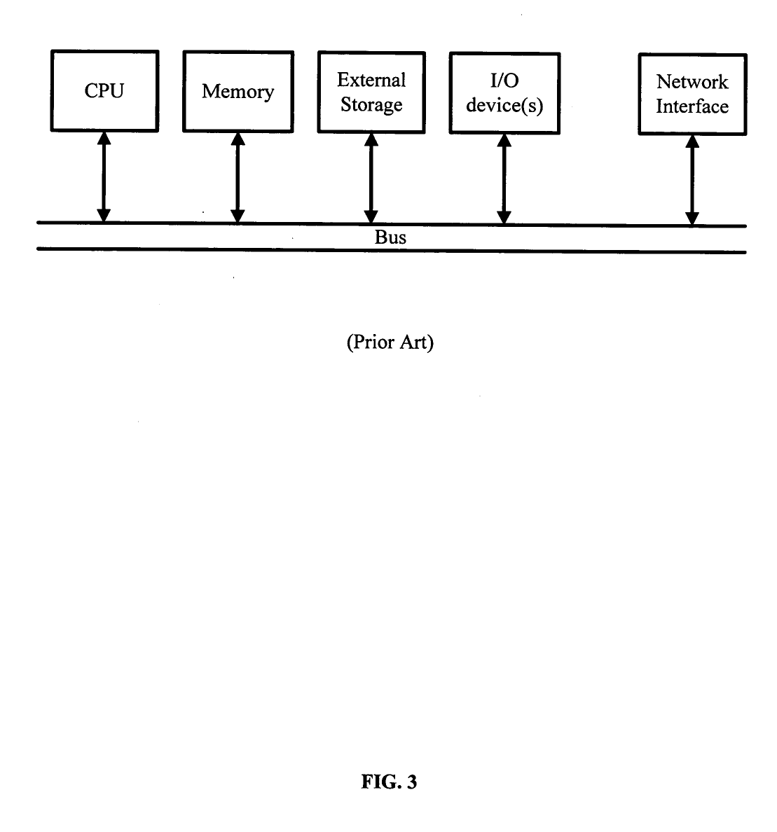

As a solution, the Neumann model can be modified by adding a network interface, as depicted in FIG. 3. Yet, even with such modification, a problem may still exist. Because all components of the Neumann model are connected to the same system bus, attackers can take over the entire computer system once they break into the system from any network port. Thus, a network interface may be added to a separate and distinct computer system bus to separate the network interface from other components, as well as general I/O devices (e.g., a keyboard, mouse, display, etc.). Separation can be achieved by having the network interface on at least one separate system bus. All other computer components can be located on one or more different system buses. By having two or more separate system buses, a bus controller may be needed to permit data to be exchanged from one system bus to another.

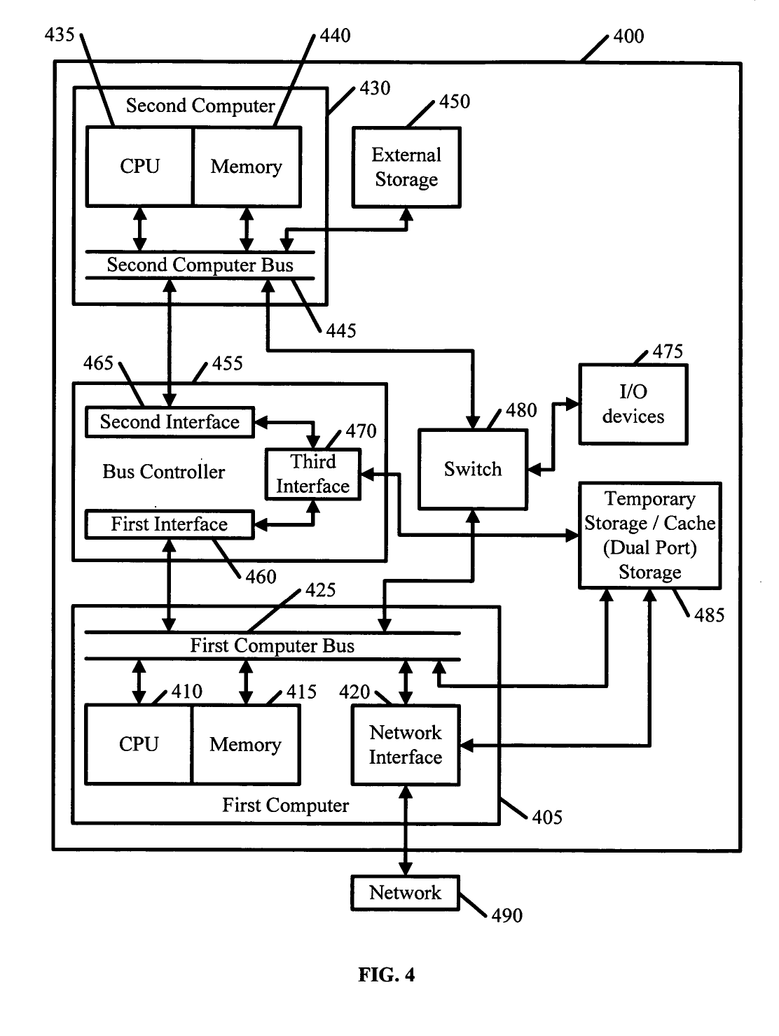

As illustrated, FIG. 4 shows an embodiment of a computer architecture 400. In the computer architecture 400, the system comprises a first computer bus 425, a network interface 420, a bus controller 455 and a temporary storage 485. The first computer bus 425 resides on the first computer 405. The network interface 420 may be interconnected with the first computer bus 425 and a network 490. The bus controller 455 may be interconnected with the first computer bus 425 and a second computer bus 445. Similar to the first computer bus 425, the second computer bus 445 resides on the second computer 430. Through the bus controller 455, the temporary storage 485 selectively interconnects with the first computer bus 425.

The bus controller 455 can be comprised of a first interface 460, a second interface 465 and a third interface 470. Each of these interfaces may be co-resident on the bus controller 455.

The first interface 460 primarily deals with data received from the network 490. The first interface 460 can be configured to communicate with a first computer bus 425 and third interface 470. The first computer bus 425 may be found residing on a first computer 405 having a network interface 420. The network interface 420 may be interconnected to the first computer bus 425 and can be configured to transfer data between the network 490 and the first computer bus 425.

The first computer 405 may include one or more of each of the following: CPU 410, internal memory 415, network interface 420 (e.g., Ethernet, wireless adaptor, etc.) and first computer bus 425. It may also include one or more I/O device 475 (e.g., keyboard, mouse, etc.) and one or more temporary storage 485. The temporary storage 485 may be a dual port storage.

Both the addition and location of the network interface 420 are significant aspects. As computers receive and/or disseminate data through the network 490, the network interface 420 should be separated from the second computer 430 (including the I/O port(s)) that perform normal computational tasks. This modification can aid in isolating the network 490 from the second computer 430 within the computer system, while further allowing data transmission through the network 490.

The second interface 465 may be involved with processing verified data into the second computer 430. Data can flow to the second interface 465 from either the temporary storage 485 via the third interface 470 or the memory 415 of the first computer 405. However, prior to receiving data, the data should be verified. Using the bus controller 455, a computer operator can command and commence data verification.

Verification is a process where data is qualified for passage from one computer to another.

The second interface 465 can be configured to communicate with a second computer bus 445 and third interface 470. The second computer bus 445 may be found residing on a second computer 430.

Similar to the first computer 405, the second computer 430 may comprise one or more of the following: CPU 435, internal memory 440 and second computer bus 445. The second computer 430 may also include a connection with an external storage 450. However, a network interface may not be present or may be disabled in the second computer 430. The second computer 430 generally does not need a network interface 420 because data that is to be received from the bus controller 455 should come from the network 490 that is interconnected with the first computer 405. To maintain a secure level for the second computer 430, only data that is received by the first computer 405 from the network 490 and that has been verified may interact with the second computer 430.

Normally, the when data transmission is not needed, the second computer 430 may handle computational functions. On the second computer 430, the network should be disabled. However, when data transmission is necessary, the bus controller 455 may use a switch 480 to switch to the first interface 460, where the first computer 405 takes control and performs communication functions. Since there may not be any external storage in the first interface 460, transmitted data tends to be stored in either the internal memory 415 or the temporary storage 485.

The switch 480 can be interconnected with the first computer bus 425 and the second computer bus 445. The switch 480 may be configured for interconnecting with the bus controller 455. Also, the switch 480 may be configured for selectively connecting the bus controller 455 to the first computer bus 425 and/or the second computer bus 445. The switch 480 may be used to help the computer operator to control the flow of data S710.

Selectively controlling data flow refers to the ability of controlling which data among all data may pass. Data that is verified may be selected to pass through the bus controller 455. Data that has been verified may not be selected to pass through the bus controller 455. Data that has not been verified should not be able to pass through the bus controller 455.

The temporary storage 485 may be combined with the bus controller 455. Data stored in the temporary storage 485 can be accessed by both the first computer bus 425 and the second computer bus 425 via the third interface 470 of the bus controller 455. In essence, the third interface 470 can be configured to communicate with the temporary storage 485. Additionally, to act as an intermediary, the third interface 470 can be configured to communicate with the first interface 460, as well as with the second interface 465.

The third interface 470 may be involved in multiple functions. These functions include receiving data from the first interface 460, verifying that data received from the first interface 460 is safe, storing data received from the first interface 460 in the temporary storage 485 and verifying that data received from the temporary storage 485 is safe.

The temporary storage, which again may be a dual port storage, 485 may differ from existing dual port external storage devices. Many that exist have multiple ports, for example, one USB port and one FireWire port. However, the ports may not be synchronized to a bus controller. Without synchronization, it is unlikely that the temporary storage 485 can be attached to the first computer bus 425 and the second computer bus 445. Here, the temporary storage 485 can be synchronized with the bus controller 455.

A digital circuit that contains at least two three-state gate arrays may be used for synchronization. The gates may be controlled in a way that at any time only one gate is enabled. Once a gate array is enabled, another gate array may be set to a high-impedence state, namely the 3^{rd} state.

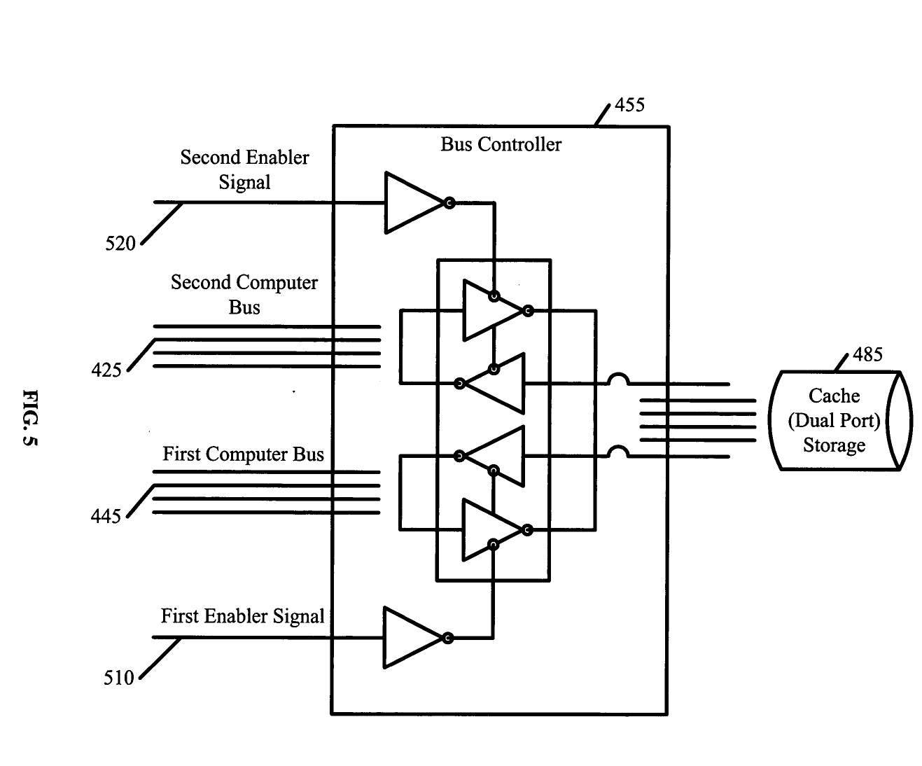

The bus controller 455 can be an operating entity that resides independently of a computer. Yet, it can also reside in either the first computer 405 (i.e., data originating computer) or second computer 430 (i.e., data-non-originating computer). FIG. 5 shows an example of simple diagram of a bus controller.

The bus controller 455 can serve as a portal or gateway to manage data exchange. Any data that is to be transmitted in this system should be passed through the bus controller 455. The bus controller 455 may be managed and controlled by the computer operator.

When data is transmitted from the network 490 via a network interface 420 of the first computer 405, the data may initially be stored in a volatile or nonvolatile memory 415 or a temporary storage component 485, S720. An example of volatile memory 415 is random access memory (RAM). An example of nonvolatile memory 415 is electrically erasable programmable read-only memory (EEPROM) or flash memory. Examples of a temporary storage component 485 include, but are not limited to, a disk drive (such as a floppy disc, compact disc, flash drive, etc.), a cache storage, etc.

Data that is stored may need to be verified prior to being exchanged to the second computer 430. The bus controller 455 can be configured to selectively control data flow S710 using a data flow verification process S730. Data flow can be verified between the first interface 460 and the third interface 470. Alternatively, data flow can be verified between the second interface 465 and the third interface 470.

The data flow verification process may be an automatic process. However, it can also be accomplished manually. This process generally involves certifying data for passage S810 from the internal memory 415 or temporary storage 485 of the first computer 405 to the internal memory 440 or external storage 450 in the second computer 430. Certification may be achieved with the aid of a digital identifying certificate S820. Examples of such certificate include, but are not limited to, digital signatures, user ID/name and password/pin, etc.

Data exchange can be achieved through the bus controller 455. To operate the bus controller 455 and initiate data flow verification, the computer operator may commence an action. For instance, the computer operator may set the second computer 430 to automatically or manually enable data access to the temporary storage 485. Enablement can be achieved by activating an enabler signal. Should a manual process be desired, the computer operator may, for example, command the verification process to start, stop or be cancelled. By requiring an action to be taken, the computer operator can maintain control over what data can be transmitted over the bus controller 455.

The data flow verification process may serve as a safety mechanism for protecting the second computer 430 from potential harms. In an embodiment, the data flow verification process involves determining whether data is stored as a result of a malicious action S910. Examples of actions include, but are not limited to, execution of a malicious program, computer infiltration, causing the hard drive to crash on a specified date and/or time, locking up the computer upon reboot, corrupting one or more files upon execution of downloaded data, etc.

Additionally, the data flow verification process may also determine whether data that is stored is part of a malicious program S920. Examples of malicious programs include, but are not limited to, viruses, worms, etc.

Besides checking the safeness of data, the data flow verification process may involve determining whether data that is to pass through the bus controller 455 may violate a security condition S930. Security conditions can include, but are not limited to, allowing only trusted material to pass, blocking third party cookies, checking signatures of downloaded programs, etc. This determination is significant to prevent infiltration into the second computer 430 during or after data transmission through the bus controller 455.

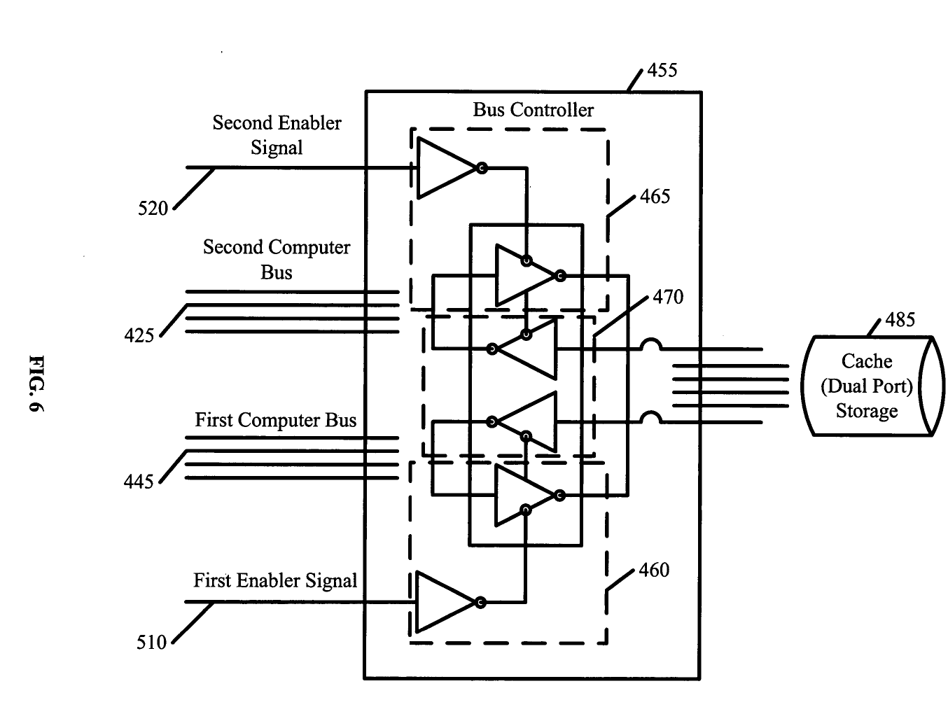

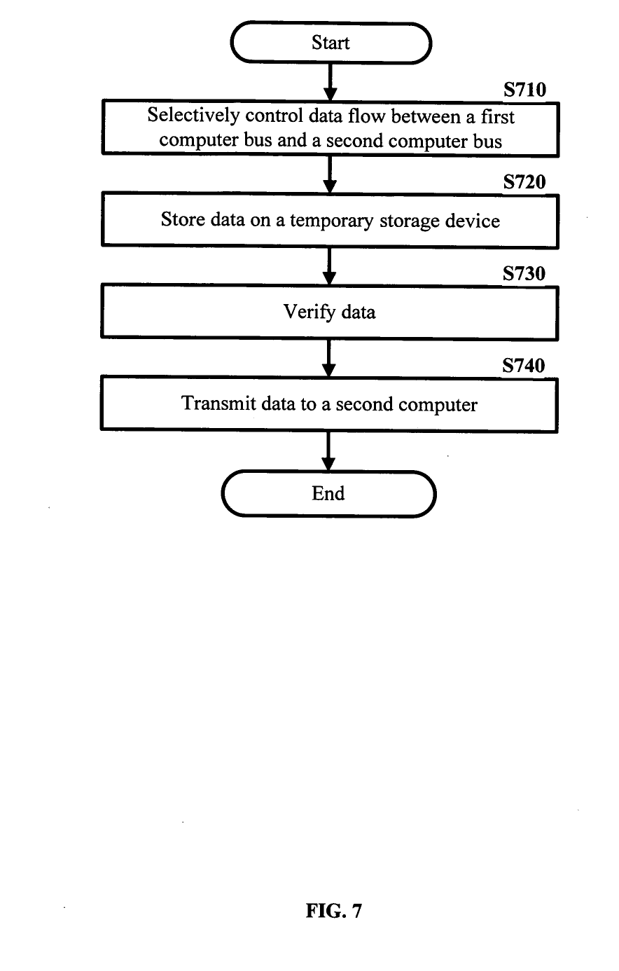

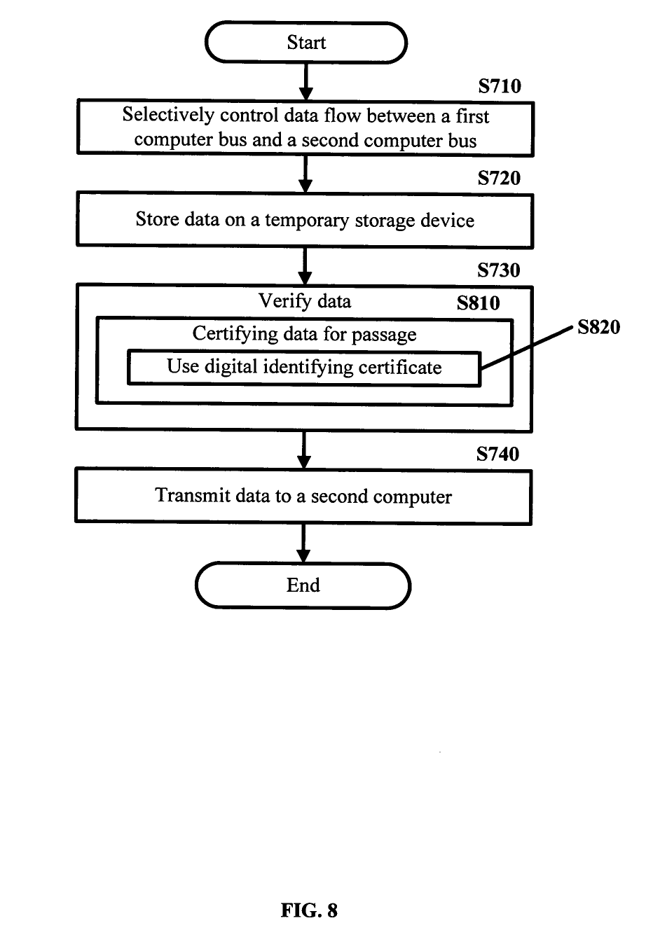

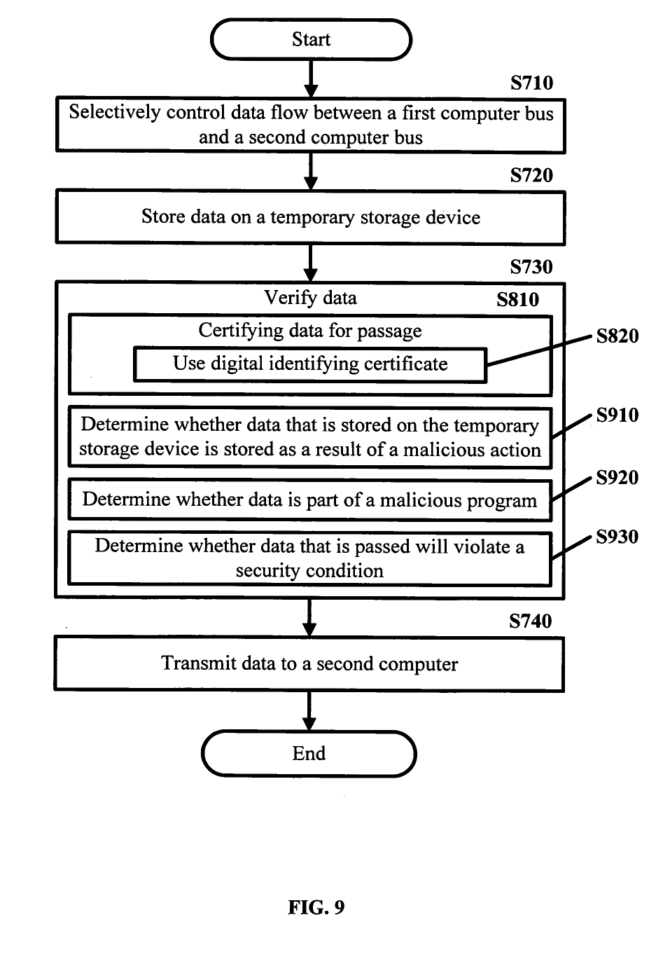

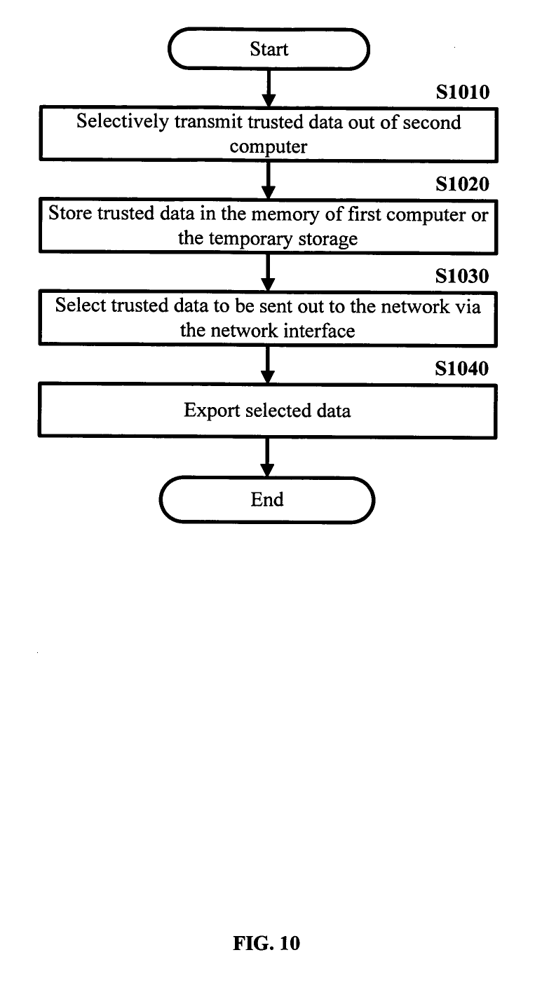

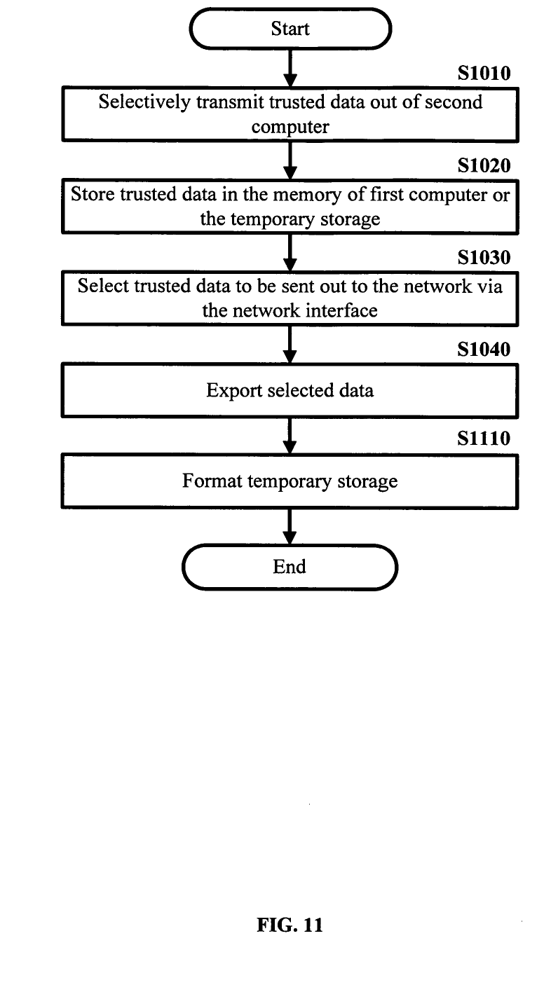

Once data has been verified, that data may be deemed as trusted data and may be ready for transmission S740. All other data that has not been or cannot be verified may be deemed as untrusted data. Before transmission can process, an enabler signal may need to be activated. The second computer bus 445 in the second interface 465 may access the temporary storage 485 only if the second enabler signal 520 is enabled. Similarly, the first computer bus 425 in the first interface 460 can access the temporary storage 485 only if the first enabler signal 510 is enabled. Both the second enabler signal 520 and the first enabler signal 510 may be controlled by the computer operator. Both signals, as shown in FIG. 6, may be interconnected with the bus controller 455. This feature helps prevent hackers from enabling any action without directly operating the computer.

Computer operators can either manually or automatically enable data access to the temporary storage 485. To automatically enable data access to the temporary storage 485, the computer operator can set the default to the second computer bus 445 so that data can be accessed directly to/from the temporary storage 485. When network communication is commenced, such as launching Internet Explorer, the first enabler signal 510 may be automatically enabled so that the first computer bus 425 can be connected. Simultaneously, the second computer bus 445 may disconnected so that the main storage 440 can be isolated. During this whole procedure, neither the first computer 405 nor the second computer 430 needs to cease computer operations. It may be the case that the second computer 430 continues execution of computer functions without any interruption.

A switch 480 may be used to switch I/O devices (e.g., the keyboard and/or mouse and display devices) between the first computer bus 425 and the second computer bus 445 either automatically or manually. For automatic switching, the switching process may be synchronized with the bus controller 455.

When the data is allowed to flow from the temporary storage 485 to the second computer bus 445, one or more files may be displayed. At this time, trusted files may be ready to be copied to the main storage 440. After data exchange is accomplished, the temporary storage 485 may be formatted.

If network transmission is further required, this process may be repeated. User data from the first computer 405 can be copied to the temporary storage 485. When the temporary storage 485 is switched to the first computer bus 425, the data may be displayed and may be ready for transmission. Data downloaded from the network 490 or Internet may then be stored on the temporary storage 485. Once stored, the data may undergo data flow verification prior to transmission to a memory in the second computer 430.

Separation of the network 490 from the second computer 430 can help thwart intrusions. With the network interface 420 located only on the first computer 405, any attempted and/or successful intrusion may result in a hacker's ability to only see and/or obtain data stored on the temporary storage 485 or the internal memory 415 of the first computer 405. Without access or permission to operate the bus controller 455, the hacker would not be able to access data that is stored in the second computer 430.

Thus, data stored in the second computer 430 (i.e., main computer) may only be accessed by the computer operator. In essence, the bus controller 455 acts as a shield to isolate user data from outside networks. Access would be denied even if the computer is hacked or taken over via an outside network.

Besides allowing data to flow into the system 400, data flow may be reversible, as shown in FIGS. 4, 10 and 11. The system also allows for trusted data stored on the second computer 430 to flow out of the system 400. Trusted data in the second computer 430 may flow from the memory 440 or external storage 450 of the second computer 430 through the second computer bus 445 to a bus controller 455, S1010. The computer operator may selectively control which trusted data may be exported from the second computer 430.

From the bus controller 445, trusted data may flow either to the temporary storage 485 or the internal memory 415 of the first computer 405, S1020. From either location, the computer operator may selective which trusted data may be sent out the system 400, S1030 to the network 490 through the network interface 420. Selected trusted data may then be exported S1040. The computer operator may selectively control data flow using the bus controller 455. As above, after data exchange is accomplished, the temporary storage 485 may be formatted S1110.

The foregoing descriptions of the embodiments have been presented for purposes of illustration and description. They are not intended to be exhaustive or to limit the invention to the precise forms disclosed, and obviously many modifications and variations are possible in light of the above teaching. The illustrated embodiments were chosen and described in order to best explain the principles of the invention and its practical application to thereby enable others skilled in the art to best utilize the invention in various embodiments and with various modifications as are suited to the particular use contemplated.

What is claimed is:

1. A bus controller comprising:
a. a first interface, said first interface configured to communicate with a first computer bus, said first computer bus residing on a first computer, a network interface interconnected with said first computer bus, said network interface configured to transfer data between a network and said first computer bus;
b. a second interface, said second interface configured to communicate with a second computer bus, said second computer bus residing on a second computer; and
c. a third interface, said third interface configured to communicate with:
i. a temporary storage;
ii. said first interface; and
iii. said second interface;
wherein said bus controller is configured to selectively control data flow using a data flow verification process between at least one of the following:
a. said first interface and said third interface; and
b. said second interface and said third interface.

2. A bus controller according to claim 1, wherein said data flow verification process is automatic.

3. A bus controller according to claim 1, wherein said data flow verification process involves certifying said data for passage.

4. A bus controller according to claim 1, wherein said data flow verification process involves an action by an operator.

5. A bus controller according to claim 1, wherein said data flow verification process determines at least one of the following:
a. whether said data that is stored on said temporary storage is stored as a result of a malicious action;
b. whether said data is part of a malicious program; and
c. whether said data that is passed will violate a security condition.

6. A method for protecting data residing on a second computer from malicious actions originating from a network, comprising:
a. selectively controlling data flow between a first computer bus and a second computer bus, said first computer bus interconnected with said network through a network interface;
b. storing said data on a temporary storage, said temporary storage connected to said first computer bus and said second computer bus through a bus controller; and
c. transmitting said data between said first computer and said second computer if said data is verified for passage.

7. A method according to claim 6, wherein said verifying is automatic.

8. A method according to claim 6, wherein said verifying involves certifying said data for passage.

9. A method according to claim 6, wherein said verifying involves an action by an operator.

10. A method according to claim 6, wherein said verifying includes determining at least one of the following:
a. whether said data that is stored on said temporary storage device is stored as a result of a malicious action;
b. whether said data is part of a malicious program; and
c. whether said data that is passed will violate a security condition.

11. A system comprising:
a. a first computer bus, said first computer bus residing on a first computer;
b. a network interface interconnected with said first computer bus and a network;
c. a bus controller interconnected with:
i. said first computer bus; and
ii. a second computer bus, said second computer bus residing on a second computer; and
d. a temporary storage selectively interconnected, through said bus controller, to said first computer bus;
wherein said bus controller selectively controls data flow between said first computer bus and said second computer bus.

12. A system according to claim 11, further including a switch, said switch interconnected with said first computer bus and said second computer bus, wherein said switch is configured for:
a. interconnecting with said bus controller; and
b. selectively connecting said bus controller to at least one of the following:
i. said first computer bus; and
ii. said second computer bus.

13. A system according to claim 11, wherein selectively controlling said data flow is automatic.

14. A system according to claim 11, wherein selectively controlling said data flow involves an action by an operator.

15. A system according to claim 11, wherein selectively controlling said data flow by way of a third interface allows the transferring of said data:
a. from a first interface connected to said first computer bus to a second interface connected to said second computer bus after said data has been verified; and
b. from said second interface connected to said second computer bus to said first interface connected to said first computer bus a after said data has been verified.

16. A system according to claim 15, wherein said first interface and said second interface connected to said second computer bus are co-resident on said bus controller.

17. A system according to claim 11, wherein selectively controlling said data flow involves determining at least one of the following:
a. whether said data flow is a result of a malicious action;
b. whether said data flow is part of a malicious program; and
c. whether said data flow will violate a security condition.

18. A system according to claim 15, wherein said first interface is involved in communicating with said network.

19. A system according to claim 15, wherein said second interface is involved in processing said data that is safe.

20. A system according to claim 15, wherein said third interface is involved in at least one of the following:
a. receiving said data from said first interface;
b. verifying said data received from said first interface is safe;
c. storing said data received from said first interface in said temporary storage; and
d. verifying said data received from said temporary storage is safe.
